(19) United States
(12) Patent Application Publication
(10) Pub. No.: US 2011/0038223 A1
(43) Pub. Date: Feb. 17, 2011

(54) MIXING SYSTEM WITH WATER SAVING FUNCTION AND USE THEREOF

(76) Inventor: Victor Antonio Ferreira Da Costa, Aveiro (PT)

Correspondence Address: KENEALY VAIDYA LLP, 515 EAST BRADDOCK RD SUITE B, Alexandria, VA, 22314, US

(21) Appl. No.: 12/989,413

(22) PCT Filed: Apr. 24, 2009
(86) PCT No.: PCT/IB2009/005378

§ 371 Date: Oct. 23, 2010

(30) Foreign Application Priority Data
Apr. 26, 2008 (PT) 104037

(51) Int. Cl. E03B 1/04; B01F 15/06; B01F 15/02

(52) U.S. Cl. 366/148

(57) ABSTRACT

The presently disclosed subject matter relates to a water mixing system that can include a mixing valve associated to an accumulation system allowing water savings in domestic systems. If the water at the inlet is not hot, it will be directed to the accumulation reservoir. If the water at inlet is hot or the accumulation reservoir is full, the water flowing through inlet will be directed to the discharge valve zone. While water is present in the accumulation reservoir it is directed to the cold water inlet preferably to the water distribution system cold water, thus promoting potable water savings. The presently disclosed subject matter is designed for civil construction industry, and more precisely for water systems for domestic use.

### FIELD OF THE INVENTION

The present invention refers to a water mixing system composed essentially by a mixing valve associated with an accumulation system allowing water savings in domestic systems. Present invention is preferably used by civil construction industry, and more precisely on water systems for domestic use.

### BACKGROUND OF THE INVENTION

Conventional mixing valves for domestic use promote mixing of two water flows, one being hot water and the other cold water, in order to allow a mixed water flow at the outlet of the valve at a temperature that meets the needs of the user, the temperature ranging between the temperatures of the cold water and hot water flows entering the mixing valve. Conventional mixing valves for domestic use have however the drawback of promoting potable water loss, i.e., when the user wants hot or partially hot water at the mixing valve outlet, but no hot water is present at the valve inlet, the outlet water is cold or partially cold thus not meeting the needs of the user, and frequently potable water is directly discharged into the sewage system.

The reason behind the non-existence of hot water at the valve inlet is associated with the piping volume between hot water source (usually a boiler or water heater) and the mixing valve, thus emerging a period of time between the hot or partially hot water demand at the valve outlet, and the arrival of hot water at the mixing valve inlet.

The absence of hot water at the valve inlet, which is relevant for the system herein proposed, is observed when a hot water demand takes place after a period during which no hot water demands were undertaken corresponding therefore to the situation wherein the hot water distribution pipe is initially filled with cold water. During the referred waiting time, the cold or partially cold potable water exiting the valve does not meet the user's temperature requirements and it is usually directly discharged into the sewage system.

There is hence the opportunity for alternative systems to those of conventional mixing valves, considering water saving devices, and allowing the use of potable water either cold or partially cold that during a given period of time enters the mixing valve through the hot water inlet, and which is usually directly discharged into the sewage system. Such alternative system should be applicable to common domestic systems, and they should not have significant operating differences when compared to the traditional mixing valve systems, as well as in terms of the installation that is associated thereto.

Up to present time some systems have been proposed to allow water savings in domestic systems, the most relevant according to the present invention being hereinafter described by chronological order:

U.S. Pat. No. 4,750,472 discloses a system based on a hot water closed circuit, a the hot water circulation being forced (by means of pump) through the hot water distribution system, in order to guarantee the existence of hot water at the inlet (or nearly at the inlet) of the devices receiving hot water. This is a system trying to partially solve the same problem as that to be solved with the present invention, but the two systems are very different, as the system proposed in U.S. Pat. No. 4,750,472 uses a pump driven by an electrical motor to force the water to return to an accumulation reservoir, while in the present invention such problem is solved by means of a purely mechanical system, without using any type of pump, providing the advantage of not needing any additional electrical system and associated power source.

U.S. Pat. No. 4,922,943 discloses a reflux and accumulation system for water leaving the domestic or industrial mixing valves, using short time periods during which the outlet water flow is not being used (such as, for example, in domestic systems, the “rinsing and soaping” periods) in order not to adjust the flow rate and the outlet temperature for a new use after the short period during which the outlet water was not used. Each hot water device includes an additional valve with two stable positions, through which one determines whether the device should operate normally or in the reflux mode and hot water saving. It is a system whose main objective is to save the water corresponding to the time periods of flow and temperature adjustment to the use needs, which is markedly different from the system herein proposed. With the system proposed by U.S. Pat. No. 4,922,943, and taking as an example the usual bath operation, only at the beginning of the bath are the flow and temperature adjusted to the user needs, and during the bath steps that do not require water, the water exiting the valve is forced to an accumulation system, the normal function of the valve (water outlet to the bath operations) or the water accumulation function being both set by the additional valve associated to the hot water using devices. In this way, water loss associated to the time period for flow and temperature adjustments to the user needs only occurs once, at the beginning of the bath, and not at the beginning of each bath phases requiring water.

By means of the system proposed in U.S. Pat. No. 4,922,943 a change on the devices using hot water is required, in order to include, each of them, an additional valve with two stable positions, and a high accumulation capacity is also required as it is necessary to accumulate not only the water corresponding to the initial adjustment of the system to the user needs, but also the water corresponding to the periods wherein water flows into the valve but is not being used by the user (periods during which the additional valve is switched in order to direct the water leaving the valve to the accumulation system). The herein proposed system does not require any additional device on the equipments using hot water, it does not require the user operation to select when the water must flow for the normal use mode or to the accumulation system (the operation mode is automatic, depending on the hot water inlet temperature in the mixing valve), and the required accumulation capacity is only that corresponding to the water volume contained in the hot water feeding pipe arranged between the hot water source and the mixing valve.

The system proposed in U.S. Pat. No. 5,165,456 carries out accumulation of the cold water during the waiting time for hot water at the outlet of the used device, to which the water is directed through a mixing valve. However, system proposed in such document does not consider the integration of the mixing valve and the accumulation system as a whole, while this integration is part of the present invention. Due to that, with the system proposed in U.S. Pat. No. 5,165,456 it is not possible to direct the water entering the hot water inlet of the mixing valve to the accumulation system or to the outlet of the mixing valve, depending on the temperature of the water entering the valve through the hot water inlet or on the filling level of the accumulation system, and the water contained in the accumulation system is not used preferably to the cold water coming from the water distribution system. Another major difference is that with the system proposed by U.S. Pat. No. 5,165,456 the water that is not lost is not accumulated under pressure, and it is to be used in any other application and/or use different from that which originated it, while with the present invention, the water that is saved is accumulated under pressure and it is later used as water entering the mixing valve, that is, it is to be used by the same application and/or use that originated it.

The system proposed in U.S. Pat. No. 6,098,213 accumulates the cold water when waiting for hot water at the outlet of the mixing valve. However, the proposed system does not consider the integration of the mixing valve and of the accumulation system as a whole, this integration being proposed in the present invention. Once again, with the system proposed in U.S. Pat. No. 6,098,213 directing the water entering the valve through the hot water inlet to the accumulation system or to the outlet of the mixing valve is not achieved depending on the temperature of the water entering the mixer through the hot water inlet or the filling level of the accumulation system, and the water contained in the accumulation system is not to be used preferably to the water coming from the cold water distribution system. Also here a major difference is that with the system proposed in U.S. Pat. No. 6,098,213 the water that is not lost is not accumulated under pressure, and it is to be used in any other application and/or use different from that which originated it, while with the present invention, the water that is saved is accumulated under pressure and it is later used as water entering the mixing valve, that is, it is to be used by the same application and/or use that originated it. With the system proposed in U.S. Pat. No. 6,098,213 water that is saved is to be used in applications/uses that do not require pressurized water, such as WC cistern filling.

### GENERAL DESCRIPTION OF THE INVENTION

The present invention refers to a water mixing system comprising a mixing valve and an accumulation system, in order to allow water savings in domestic systems. The proposed system according to the present invention, has characteristics allowing it to be used with water saving function, namely a water mixing valve and a water accumulation system.

This system is characterized in that it comprises:

a) A mixing valve, comprising the dilatable bulb (2) assembled over a drilled fixed disk (1), the dilatable bulb being attached to a rod (3) that abuts the drilled piston (4), which is linked through rod (6) to piston (7) which is pushed from the right to the left by the spring (5), two levers setting the hot water (9) and cold water (10) inlets, and a check valve (22); and
b) A water accumulation device including a water accumulation reservoir (18), two springs (19, 20) that abut piston (21) and the check valve (22).

When opening the hot water flow inlet (9) of the mixing valve, but there is no hot water available at the inlet (11) of the mixing valve, the cold or partially cold water entering the valve through the hot water inlet (11) is directed to the accumulation reservoir (18), where it remains stored under pressure. Only when hot water is present at the inlet (11) of the valve, or when the accumulation system is fully charged with water, the water entering the mixing valve through the hot water inlet (11) is directed straight to the mixing valve discharge (13). Water retained in the accumulation reservoir (18) is directed so as to enter the mixing valve through the cold water inlet (12), as if it was cold water coming from the water distribution system, the system giving preference to the use of the accumulated water in the accumulation reservoir (18), that is, while water is present in the accumulation reservoir (18) it is conducted to the cold water inlet (12) of the mixing valve preferably the cold water from the water distribution system (17).

The system is operated by the user as a normal mixing valve through the operation over two levers that set the flow rates of hot (11) and cold (12) water inlets. During the period of time when hot or partially hot water is expected at the valve outlet (13), but no hot water is present at the hot water inlet (11) and the accumulation reservoir is not fully charged with water, the cold or partially cold water entering the valve through the hot water inlet (11) is directed to the accumulation reservoir (18), and during such period of time there is no water discharge at the outlet (13) of the mixing valve. Absence of hot water at the hot water inlet (11) is due to the piping volume between the hot water source (usually a boiler or water heater) and the mixing valve, thus emerging a time delay between the hot water demand at the valve outlet and the existence of hot water at the inlet (11) of the mixing valve. The capacity of the accumulation reservoir (18) is dictated mainly by the conjugation of two factors: the volume of water that one wants to save, and the volume of the piping between the hot water source and the mixing valve.

### DESCRIPTION OF THE DRAWINGS

FIG. 1—Schematic representation of the proposed mixing valve, wherein the numbers referring to:
1—Drilled and fixed disk
2—Dilatable bulb
3—Rod
4—Drilled piston
5—Spring
6—Rod
7—Piston
8—Check valve
9—Hot water closure/inlet
10—Cold water closure/inlet
11—Hot water inlet in the mixing valve
12—Cold water inlet in the mixing valve
13—water outlet from the valve for usage purposes
14—Water outlet from the valve to the accumulation system

FIG. 2—schematic representation of the accumulation system working together with the proposed mixing valve, wherein the numbers refer to:
15—Accumulation system inlet
16—Water outlet from the accumulation system to the cold water inlet of the mixing valve
17—Cold water inlet from the water distribution system
18—Accumulation reservoir
19—Spring
20—Spring
21—Piston
22—Check valve

The mixing valve and the accumulation system work together, as illustrated in FIGS. 3 and 4.

FIG. 3—schematic representation of the integrated system with the intended potable water saving function, consisting of the mixing valve and accumulation system.

FIG. 4—simplified schematic representation of the integrated system in FIG. 3.

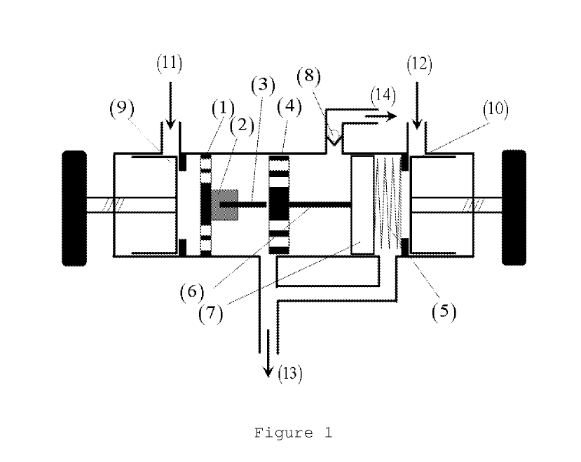

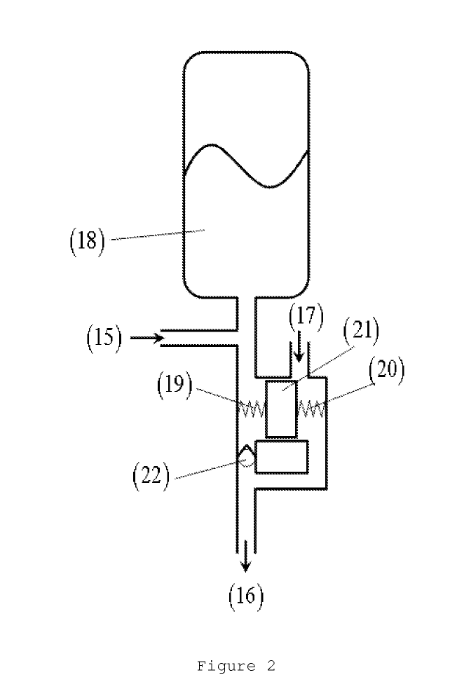

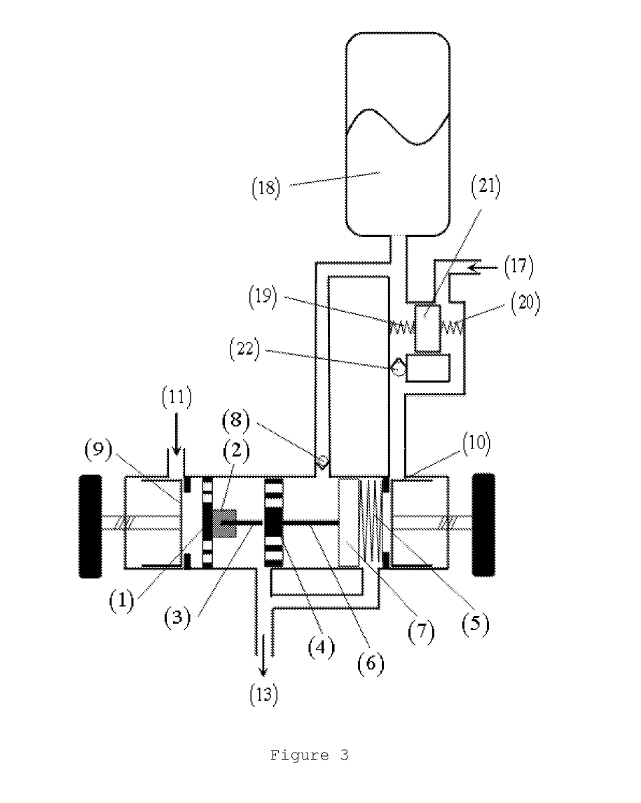

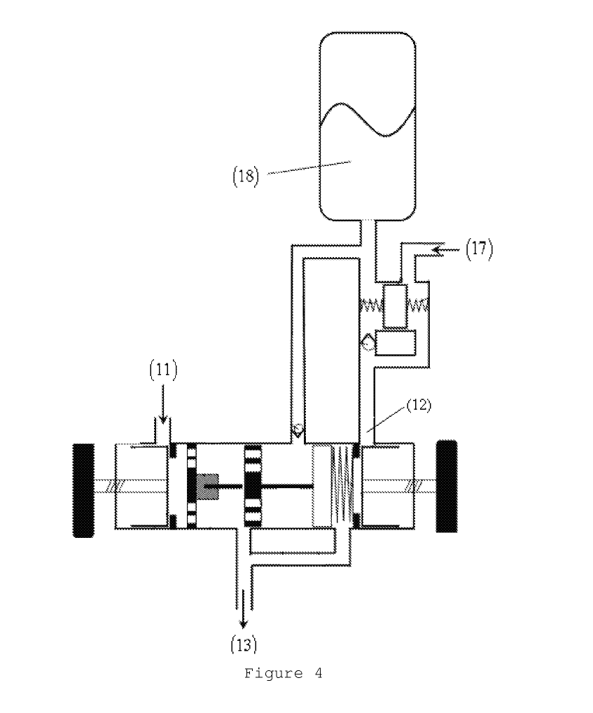

Reference numbers in FIGS. 3 and 4 refer to the same elements as indicated before, and they are thus addressed through the same reference numbers.

The accumulation system presented in FIG. 2 might be housed in the most adequate place, but it should be as close as possible to the mixing valve schematically shown in FIG. 1. Outlet (16) of the accumulation system in FIG. 2 is linked to the inlet (12) of the mixing valve, and the outlet (14) of the mixing valve in FIG. 1 is linked to the inlet (15) of the accumulation system in FIG. 2.

The proposed system does not present additional difficulties in terms of installation as the two additional ways to transfer water between the valve and accumulation system can be installed in parallel by normal means corresponding to the hot (11) and cold (12) water inlets of the valve. However, in this case, and as illustrated in FIG. 3, there is no need to feed the mixing valve directly with cold water from the water distribution system. In terms of installation of the system, the cold water inlet from the water distribution system (17) is in the accumulation system, and the hot water inlet is made in normally, through the hot water inlet (11) of the mixing valve, as illustrated in FIG. 3.

There are two additional pipes between the mixing valve in FIG. 1 and the accumulation system in FIG. 2, wherein the system is to be connected in the following way: (i) the water to be saved exits the mixing valve in FIG. 1 through connection (14), thus entering the accumulation system in FIG. 2 through inlet (15) in this figure; and (ii) outlet (16) of the accumulation system is connected to the inlet (12) of the mixing valve. In this case, as illustrated in FIG. 3, there is not needed to feed the mixing valve directly with cold water from the water distribution system. The system as a whole is represented in FIGS. 3 and 4.

### DETAILED DESCRIPTION OF THE INVENTION

The temperature sensor element, which evaluates the temperature of the hot water at inlet (11) of the mixing valve, is the dilatable bulb (2) in FIG. 1, whose swelling is converted into a horizontal linear deformation (length increase), taking FIG. 1 as reference.

When both inlets (11,12) of the mixing valve are totally closed (9, 10), such that it is guaranteed the closure (9) of the hot water inlet (11) and the closure (10) of the cold water inlet (12), there are no water flows entering the mixing valve and consequently there is no outlet water flow at the outlet (13) of the mixing valve in FIG. 1.

Reference being made to FIG. 1, if the hot water inlet (9) is total or partially opened, thus allowing inlet hot water (11) in the mixing valve, but the entering water is not hot water, water flows through the drills in fixed disk (1), and as it is cold the dilatable bulb (2) does not increase its dimension, that is abutted to piston (4) through rod (3), the piston (4) being pushed to the left by the action of the spring (5), and piston (4) closes the eventual opening allowing the outlet of water entering through inlet (11) towards the outlet (13) of the mixing valve, which is the main water outlet of the mixing valve.

Reference being made to FIG. 1, the hot water flow (11) that cannot flow towards the outlet (13) of the mixing valve, flows through the drills in piston (4), through the check valve (8), through the outlet (14) of the mixing valve to the accumulation system, and it reaches the accumulation reservoir (18) shown in FIG. 2. As the accumulation reservoir (18) receives water, pressure inside it increases; thus also increasing the pressure at which water flow (14) exits the mixing valve, this pressure exerting influence on piston (7), and the set formed by pistons (4) and (7) and rod (6) is forced to move to the right, and piston (4) reaches a position such that it allows the outlet of water flow (11) towards the outlet (13) of the mixing valve in FIG. 1. If the cold water inlet (10) is opened when the hot water inlet (9) in FIG. 1 is kept open, the cold water is directed towards the outlet (13) of the mixing valve no matter the temperature of the hot water flow (11) at the mixing valve (11), and the amount of water in the accumulation reservoir (18) in FIG. 2. If both flows of hot (11) and cold (12) water enter the mixing valve, and if there is no hot water at the hot water inlet (11), dilatable bulb (2) does not swell and, by action of spring (5) piston (4) is forced to the left and does not allow the water flow (11) to flow towards the outlet (13) of the mixing valve, and it is directed to the accumulation reservoir (18) if it is not fully charged with water, and cold water flow (10) is directed towards the outlet (13) of the mixing valve. If both currents of hot (11) and cold (12) water enter the mixing valve in FIG. 1, and if there is no hot water at the hot water inlet (11), but accumulation reservoir (18) is fully charged with water, the flow pressure (11) that cannot reach exit increases, and this pressure exerts influence on piston (7) forcing the set formed by pistons (4) and (7) and rod (4) to move to the right, piston (4) reaches a position that allows the outlet of the water flow (11) towards the outlet (13) of the mixing valve, and the cold water flow (12) is also directed to the outlet (13) of the mixing valve. Reference being made to FIG. 1, if both hot (11) and cold (12) water flows enter the mixing valve, and if water is present at the hot water inlet (11), dilatable bulb (2) swells and, by action of rod (3) that abuts piston (4), the later is forced to move to the right, and allows the water flow (11) to flow to the outlet (13) of the mixing valve, and cold water current (12) is directed towards the outlet (13) of the mixing valve, thus resulting in water at the desired temperature at outlet (13). This situation corresponds to the normal operation of the mixing valve.

The cold water flow (12) entering the mixing valve in FIG. 1 is always directed towards the outlet (13) of the mixing valve and the water saving function of the system is mainly related to saving water entering the mixing valve through the hot water inlet (11), when it is not hot but rather cold or partially cold. The cold water flow (12) entering the mixing valve comes from the accumulation system shown in FIG. 2.

If the accumulation reservoir (18) is not fully charged, by action of spring (20) piston (21) moves to the left, thus allowing the direct flow of cold water (17) from the water distribution system towards the cold water inlet (12) of the mixing valve in FIG. 1. If the accumulation reservoir (18) is fully or partially charged with water, piston (21) moves to the right by action of the pressure inside accumulation reservoir (18) and spring (19), and does not allow the passage of cold water (17) directly to the cold water inlet (12) of the mixing valve.

When the accumulation reservoir (18) is charged with water, piston (21) is forced to the right by action of the pressure inside the accumulation reservoir (18) and spring (19), and does not allow the passage of cold water (17) directly to the cold water inlet (12) of the mixing valve, but the passage of the water contained in the accumulation reservoir (18) towards the cold water inlet (12) of the mixing valve is always possible thus embodying a system that preferably uses the water accumulated in the accumulation reservoir (18) instead of the cold water (17) from the water distribution system to feed the mixing valve through cold water inlet (12).

Passage of water contained in the accumulation reservoir (18) towards the cold water inlet (12) of the mixing valve is always possible, through the check valve (22).

In terms of operation, the proposed system is operated in the same way as common mixing valves, the main difference being that when the water flow entering the mixing valve through the hot water inlet (11) is being directed towards the accumulation reservoir (18) there is no corresponding outlet through the main outlet (13) of water flow entering inlet (11) of the mixing valve in FIG. 2.

1. Mixing system with water saving function, comprising:
a) a mixing valve that includes a dilatable bulb assembled on a drilled attached disk, the dilatable bulb being connected to a rod abutting the drilled piston which is attached by means of rod to another piston, which is pushed from the right to the left by action of a spring, two levers setting the opening and the closure of the hot and cold water inlets, and a check valve; and
b) a water accumulation system including an accumulation reservoir, two springs abutting piston, and a check valve.

2. Mixing system with water saving function according to claim 1, wherein the system has levers for opening or closing the hot and cold water inlets, thus setting the flow rates of hot water and cold water entering in the mixing valve through inlets and, respectively, the water leaving through mixing valve outlet, and saving the water in the accumulation reservoir, which entered therein through the passage between the valve and the accumulation reservoir when no hot water is present at the hot water inlet.

3. Mixing system with water saving function according to claim 1, wherein the system has a cold water inlet from the water distribution system, this water flowing towards the outlet of the accumulation system and respective cold water inlet.

4. Mixing system with water saving function according to claim 1, wherein the system has two additional pipes linking the accumulation system and the mixing valve.

5. Mixing system with water saving function according to claim 1, wherein the system is configured to uses the water accumulated under pressure in the accumulation reservoir, without needing additional means (either mechanical or others) for pressurizing the accumulated water.

6. Method for operating the mixing system with water saving function according to claim 1, wherein the method comprises the following operational steps:
a) when no hot water is present at the mixing valve inlet, cold or partially cold water enters the mixing valve through the hot water inlet and since dilatable bulb does not swell the water flow is directed towards the water accumulation reservoir through the mixing valve outlet, entering into the accumulation device through inlet towards the accumulation reservoir, this process ending when hot water reaches the valve inlet or when the accumulation reservoir is fully filled with water;
b) when hot water enters through the mixing valve inlet, dilatable bulb swells, and rod forces the piston to the right, such that hot water exits through the mixing valve normal outlet;
c) when the accumulation reservoir is charged with water, water entering through the hot water inlet is discharged through the mixing valve normal outlet.

7. . Mixing system with water saving function according to claim 1, wherein the mixing valve receives hot water and feeds mixed water, and that when hot water is absent at the inlet the cold or partially cold water is directed towards the accumulation reservoir, which can also receive cold water from the water distribution system, and releases cold water to mixing valve inlet.

8. Mixing system with water saving function according to claim 7, wherein water accumulation is made with cold or partially cold water entering in the mixing valve through hot water inlet, this accumulated water being afterwards used to feed the cold water inlet flow of the mixing valve.

9. Mixing system with water saving function according to claim 1, wherein the accumulation system uses the water contained in the accumulation reservoir instead of the cold water from the water distribution system in order to feed the mixing valve with cold water through inlet.

10. Mixing system with water saving function according to claim 1, wherein the system is operated through two levers setting the hot and cold flow rates entering the mixing valve.

11. Method for operating the mixing system with water saving function according to claim 2, wherein the method comprises the following:
a) when no hot water is present at the mixing valve inlet, cold or partially cold water enters the mixing valve through the hot water inlet and since dilatable bulb does not swell the water flow is directed towards the water accumulation reservoir through the mixing valve outlet, entering into the accumulation device through inlet towards the accumulation reservoir, this process ending when hot water reaches the valve inlet or when the accumulation reservoir is fully filled with water;
b) when hot water enters through the mixing valve inlet, dilatable bulb swells, and rod forces the piston to the right, such that hot water exits through the mixing valve normal outlet;
c) when the accumulation reservoir is charged with water, water entering through the hot water inlet is discharged through the mixing valve normal outlet.

12. Method for operating the mixing system with water saving function according to claim 3, wherein the method comprises the following:
a) when no hot water is present at the mixing valve inlet, cold or partially cold water enters the mixing valve through the hot water inlet and since dilatable bulb does not swell the water flow is directed towards the water accumulation reservoir through the mixing valve outlet, entering into the accumulation device through inlet towards the accumulation reservoir, this process ending when hot water reaches the valve inlet or when the accumulation reservoir is fully filled with water;
b) when hot water enters through the mixing valve inlet, dilatable bulb swells, and rod forces the piston to the right, such that hot water exits through the mixing valve normal outlet;
c) when the accumulation reservoir is charged with water, water entering through the hot water inlet is discharged through the mixing valve normal outlet.

13. Mixing system with water saving function according to claim 2, wherein the mixing valve receives hot water and feeds mixed water, and that when hot water is absent at the inlet the cold or partially cold water is directed towards the accumulation reservoir, which can also receive cold water from the water distribution system, and releases cold water to mixing valve inlet.

14. Mixing system with water saving function according to claim 3, wherein the mixing valve receives hot water and feeds mixed water, and that when hot water is absent at the inlet the cold or partially cold water is directed towards the accumulation reservoir, which can also receive cold water from the water distribution system, and releases cold water to mixing valve inlet.

15. Mixing system with water saving function according to claim 2, wherein the accumulation system uses the water contained in the accumulation reservoir instead of the cold water from the water distribution system in order to feed the mixing valve with cold water through inlet.

16. Mixing system with water saving function according to claim 3, wherein the accumulation system uses the water contained in the accumulation reservoir instead of the cold water from the water distribution system in order to feed the mixing valve with cold water through inlet.

17. Mixing system with water saving function according to claim 4, wherein the accumulation system uses the water contained in the accumulation reservoir instead of the cold water from the water distribution system in order to feed the mixing valve with cold water through inlet.

18. Mixing system with water saving function according to claim 5, wherein the accumulation system uses the water contained in the accumulation reservoir instead of the cold water from the water distribution system in order to feed the mixing valve with cold water through inlet.

19. Mixing system with water saving function according to claim 2, wherein the system is operated through two levers setting the hot and cold flow rates entering the mixing valve.

20. Mixing system with water saving function according to claim 3, wherein the system is operated through two levers setting the hot and cold flow rates entering the mixing valve.
